(19) United States
(12) Patent Application Publication
(10) Pub. No.: US 2014/0024774 A1
(43) Pub. Date: Jan. 23, 2014

(54) CONDENSATION REACTION CURABLE SILICONE ORGANIC BLOCK COPOLYMER COMPOSITION CONTAINING A PHOSPHONATE CATALYST AND METHODS FOR THE PREPARATION AND USE OF THE COMPOSITION

(71) Applicants: Simon Cook, Midland, MI (US); Geraldine Durand, Cardiff (GB); Thomas Easton, Barry (GB); Sarah O'Hare, Barry (GB); Avril Surgenor, Waterloo (BE); Richard Taylor, Penarth (GB)

(72) Inventors: Simon Cook, Midland, MI (US); Geraldine Durand, Cardiff (GB); Thomas Easton, Barry (GB); Sarah O'Hare, Barry (GB); Avril Surgenor, Waterloo (BE); Richard Taylor, Penarth (GB)

(21) Appl. No.: 14/007,734

(22) PCT Filed: Mar. 12, 2012
(86) PCT No.: PCT/US12/28687

§ 371 Date: Sep. 26, 2013

Related U.S. Application Data
(60) Provisional application No. 61/469,836, filed on Mar. 31, 2011.

(51) Int. Cl. C08G 77/46; C09D 183/12; C08K 5/5419

(52) U.S. Cl. CPC C08G 77/46; C08K 5/5419; C09D 183/12
USPC 524/862; 528/23

(57) ABSTRACT

A condensation reaction curable composition comprises a new catalyst, Dow Corning® 4-6085, and a polyorganosiloxane polyoxyalkylene block copolymer having one or more polyorganosiloxane blocks and one or more polyoxyalkylene blocks linked to each other via divalent radicals which comprises at least two silicon-bonded alkoxy groups, preferably of the form PS-(A-PO)ₘ-(A-PS)ₙ, wherein PO is a polyoxyalkylene block, PS represents a polyorganosiloxane block, A is a divalent radical, subscripts m and n have independently a value of at least 1, comprising at least one alkoxy-substituted siloxane unit of the formula (R′)_{q}(OR)—SiO_{3-q/2}, wherein R represents an alkyl group having 1 to 4 carbon atoms and each R′ represents an alkyl group having 1 to 6 carbon atoms, a phenyl group, or an alkoxy group of the formula —OR and subscript q has a value of 0, 1 or 2, provided at least two silicon-bonded groups OR are present in the block copolymer.

### CROSS-REFERENCE TO RELATED APPLICATIONS AND STATEMENT REGARDING FEDERALLY SPONSORED RESEARCH

This application claims the benefit of U.S. Provisional Patent Application No. 61/469,836 filed 31 Mar. 2011 under 35 U.S.C. §119 (e). U.S. Provisional Patent Application No. 61/469,836 is hereby incorporated by reference.

### TECHNICAL FIELD

A condensation reaction curable composition comprises a silicone organic block copolymer having hydrolyzable groups and a phosphonate catalyst. The composition cures in the presence of moisture to form a cured product. A water-insoluble hydrophilic polymer network can be made from the curable composition.

### BACKGROUND

Polyorganosiloxane compositions generally have a low surface energy and are hydrophobic. For some uses of polyorganosiloxane compositions, a hydrophilic polymer is required to give improved wetting of a polymer surface by an aqueous liquid contacting the surface, while retaining some of the advantageous properties of the polyorganosiloxane.

JP-A-2001-106781 describes a silane modified polyether obtained by reacting a polyoxyalkylene glycol with a silicate compound, optionally in the presence of an ester exchange catalyst. The product is moisture curable and useful as a sealant or adhesive.

JP-2007-238820 relates to a hydrophilic organopolysiloxane cured product and its application in coating to provide superior self-cleaning, antistatic, antifouling and low contamination properties. They are based on organopolysiloxane having at least 2 silanol groups and a hydrophilic group, with the silanol groups capable of condensation reaction to form the cured product.

The use of polyorganosiloxane polyoxyalkylene block copolymers, where the polyoxyalkylene is reacted into the backbone of the copolymer, is particularly useful for the reaction into polymer networks via condensation reaction, which networks exhibit hydrophilic properties.

### SUMMARY OF THE INVENTION

A condensation reaction curable composition comprises:

(A) a silyl phosphonate catalyst, and
(B) a polyorganosiloxane polyoxyalkylene block copolymer.

The composition cures in the presence of moisture to form a cured product.

### DETAILED DESCRIPTION OF THE INVENTION

### Ingredient (A) Catalyst

Ingredient (A) comprises a phosphonate catalyst. The phosphonate has average general formula (i):

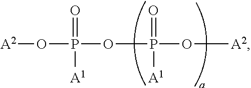

where
each A¹ is independently a monovalent hydrocarbon group;
each A² is independently selected from a hydrogen atom, a monovalent organic group, a silyl group of formula —SiA³₃, where each A³ is independently a monovalent hydrocarbon group, or a siloxane group; and
subscript a has a value of 0 or greater.

Alternatively, in formula (i) above, each group A¹ is independently a monovalent hydrocarbon group; and each A² is independently a hydrogen atom, a monovalent hydrocarbon group, or a silyl group. Examples of monovalent hydrocarbon groups for A¹, A², and A³ include, but are not limited to, alkyl such as methyl, ethyl, propyl, pentyl, hexyl, heptyl, ethylhexyl, octyl, decyl, dodecyl, undecyl, and octadecyl; alkenyl such as vinyl, allyl, propenyl, and hexenyl; cycloalkyl such as cyclopentyl and cyclohexyl; aryl such as phenyl, tolyl, and xylyl; alkaryl such as benzyl; and aralkyl such as 2-phenylethyl. Subscript a may have a value ranging from 0 to 50, alternatively 0 to 20. Alternatively, when ingredient (A) is a monomeric phosphonate, subscript a has a value of 0. Alternatively, each A¹ is independently an alkyl group of 1 to 8 carbon atoms or an alkenyl group of 1 to 8 carbon atoms; and each A² is independently a hydrogen atom, an alkyl group of 1 to 4 carbon atoms, or a silyl group in which each A³ is independently an alkyl group of 1 to 4 carbon atoms. Examples of suitable alkyl groups for A¹ and A² and A³ are methyl, ethyl, propyl, butyl, hexyl, ethylhexyl, and octyl. Alternatively, each A¹ and each A³ may be independently selected from methyl, vinyl, and octyl. Alternatively, each A² may be independently selected from a hydrogen atom or a silyl group. Alternatively, each A² may be independently selected from a hydrogen atom or an organic group. Alternatively, each A² may be independently selected from a hydrogen atom or a monovalent hydrocarbon group, such as alkyl or alkenyl; alternatively alkyl. One skilled in the art would recognize that average formula (i) can represent an equilibrium mixture of species, where at least some of the molecules of formula (i) present contain a silyl group and some of the molecules of formula (i) do not contain a silyl group.

Alternatively, ingredient (A) may comprise diethenyl-diphosphonic acid, vinylphosphonic acid, bis(trimethylsilyl)vinylphosphonate, trimethylsilyl vinylphosphonic acid, bis(dimethylvinylsilyl)vinylphosphonate, dimethylvinylsilyl vinylphosphonic acid, dimethyl methylphosphonate, bis(trimethylsilyl)octylphosphonate, trimethylsilyl octylphosphonate, octylphosphonic acid, or a combination thereof. Alternatively, ingredient (A) may comprise a mixture of bis(trimethylsilyl)octylphosphonate, trimethylsilyl octylphosphonate, and octylphosphonic acid.

Phosphonates are commercially available. For example, DOW CORNING® 4-6085 is a mixture comprising monomeric silyl phosphonate and monomeric organic phosphonate species; DOW CORNING® 4-6025 is a mixture comprising monomeric and polymeric phosphonate species; and DOW CORNING® 4-6035 is also a commercially available phosphonate. These phosphonates are all available from Dow Corning Corporation of Midland, Mich., U.S.A. Dimethyl methylphosphonate is also commercially available.

### Ingredient (B) Block Copolymer

Ingredient (B) of the composition is a polyorganosiloxane polyoxyalkylene block copolymer having one or more polyorganosiloxane blocks and one or more polyoxyalkylene blocks linked to each other via divalent radicals. The block copolymer comprises at least two silicon-bonded alkoxy groups.

The polyorganosiloxane polyoxyalkylene block copolymer may have formula PS-(A-PO)ₘ-(A-PS)ₙ, where PO is a polyoxyalkylene block, PS represents a polyorganosiloxane block, A is a divalent radical, subscripts m and n each independently have a value of at least 1. The polyorganosiloxane polyoxyalkylene block copolymer comprises at least one alkoxy-substituted siloxane unit of the formula (R′)_{q}(OR)—SiO_{3-q/2}, where R represents an alkyl group having 1 to 4 carbon atoms and each R′ represents an alkyl group having 1 to 6 carbon atoms, a phenyl group, or an alkoxy group of the formula —OR and q has a value of 0, 1 or 2, provided at least two silicon-bonded groups OR are present in the block copolymer. Preferably, the alkoxy groups are selected from methoxy groups and ethoxy groups. Alternatively, each OR group is a methoxy group. Alternatively, each OR group is an ethoxy group.

It is preferred that the polyorganosiloxane polyoxyalkylene block copolymer is such that the terminal PS blocks represent a polyorganosiloxane block terminated with an alkoxy-substituted siloxane unit which is linked via oxygen to another silicon atom of the PS block and which has the formula

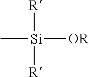

wherein R and R′ are as defined above. In other words, it is preferred that the alkoxy-substituted siloxane units forms part of a PS block. It is also preferred that at least two separate silicon atoms in the block copolymer are substituted with at least one silicon-bonded alkoxy group OR.

The blocks (A-PO) and (A-PS) of the preferred block copolymer, may be randomly distributed throughout the block copolymer. The values of subscripts m and n may be any value, preferably however no more than 100, more preferably no more than 20, most preferably no more than 5. It is particularly preferred that m and n are 1. Each R′ preferably denotes an alkoxy group —OR. Particularly preferred polyorganosiloxane polyoxyalkylene block copolymers have the formula PS-(A-PO-A-PS)ₙ, where PO, PS, A and n have the definitions provided above.

The preferred polyorganosiloxane polyoxyalkylene block copolymer according to the invention generally comprises at least two polyorganosiloxane blocks and at least one polyoxyalkylene block. The alkoxy group substituted siloxane units, which will form cross-linkable reactive groups X for making of the hydrophilic polymer networks according to another aspect of this invention, are most preferably terminal siloxane units of the polyorganosiloxane polyoxyalkylene block copolymer, although this is not essential. The cross-linkable reactive alkoxy group X may however be situated in any siloxane unit in the block copolymer, including those of any polyorganosiloxane block of the block copolymer.

Alternatively the polyorganosiloxane polyoxyalkylene block copolymer may have the form PO-(A-PS)ₘ-(A-PO)ₙ or the form PO-(A-PS-A-PO)ₙ where PO, PS, A, m and n are as defined above. These block copolymers may still have one or more groups X which are located in pendant positions on the PS moiety. Alternatively the siloxane units comprising the X group may be located at the end of the PO block. These block copolymers are however less preferred for use in the hydrophilic polymer networks described below.

The PS blocks comprise siloxane units of the general formula

R″ᵣSiO_{(4-r/2)}

where R″ represents OR, alkyl, aryl, alkaryl or aralkyl preferably having from 1 to 18 carbon atoms and subscript r denotes a value of from 0 to 3. Preferred in addition to being OR, R″ is an alkyl group having from 1 to 6 carbon atoms or a phenyl group, although more preferred such R″ denotes an alkyl group having from 1 to 3 carbon atoms, most preferably methyl. It is preferred that only up to 4 R″ groups in the block copolymer denote OR groups, more preferably only 2, and these being preferably present on the terminal silicon atoms of the block copolymer, which means that for the preferred block copolymers only the terminal PS blocks would have at least one silicon-bonded OR group present each. It will be clear to the person skilled in the art that, where the block copolymers are of the type where the PO blocks are terminal, only those R groups in the PS block could be OR which are reacted onto a PS precursor block having at least three hydrogen atoms, if these are reacted in via hydrosilylation of an alkoxy containing organosilicon compound with at least one unsaturated aliphatic substituent. On average for the PS block the value of subscript r may range from 1.6 and 2.4, alternatively 1.9 to 2.1. However, siloxane units where subscript r has a value of 3 will be present as terminal groups, which is particularly desirable for the siloxane units on which a silicon-bonded OR is located. In addition some siloxane units with a value for subscript r of 0 or 1 may also be present, but these are preferably kept to a minimum, such as no more than 2% of the total siloxane units in the PS blocks, as they introduce branching into the PS block.

Most preferred, therefore, are terminal PS blocks, which are polydimethylsiloxane moieties, which may be end-blocked by alkoxy substituted siloxane units on one side and which may linked to the divalent linking group A on the other side. Where subscript m and/or subscript n has a value greater than 1, the more central PS block(s) will be linked to an A group on both sides. The number of siloxane units in each PS block is not crucial, and will be selected in view of the desired properties of the block copolymer or the hydrophilic polymer network resulting from it. Preferably, the PS block(s) will have from 2 to 200 siloxane units, more preferably from 4 to 40, most preferably from 10 to 30.

The PO block is a polyoxyalkylene block having the general formula

—(CₛH₂ₛO)ₜ—

where each subscript s independently has a value ranging from 2 to 6, alternatively 2 to 3, and subscript t has a value ranging from 1 to 100, alternatively 4 to 40, and alternatively 3 to 10. Where the block copolymers having terminal PO blocks are used, the above general formula for the terminal PO blocks would be

Q-(CₛH₂ₛO)ₜ—

where Q denotes an end-blocking group for the polyoxyalkylene, for example an alkyl group, a hydroxyl group or an acyl group, or a group being or comprising an alkoxy group, including an alkoxy-substituted silane or siloxane group. Examples of the polyoxyalkylene blocks include polyoxyethylene blocks, polyoxypropylene blocks, polyoxyethylene-oxypropylene blocks, polyoxyisopropylene blocks and blocks containing a mixture of the different type of alkylene units as the most preferred. At least 50% of the polyoxyalkylene units in the polyoxyalkylene block are preferably oxyethylene units to give the required hydrophilic properties.

The relative amounts of PS and PO blocks is not limited, but may be adapted to the particular end-use which is envisaged. Where a more hydrophilic nature is desired, a larger proportion by weight of the PO blocks, especially those containing polyoxyethylene units, will be selected as a proportion to the total weight of the block copolymer used in the making of the hydrophilic polymer network. Where hydrophilicity is not needed to the same extent, the proportion by weight of the PO blocks may be smaller, although the composition of the PO block may vary instead, e.g., by providing less polyoxyethylene units therein. The molar ratio of oxyalkylene, for example oxyethylene, units to siloxane units in the polyorganosiloxane polyoxyalkylene block copolymer is preferably in the range 0.05:1 to 0.5:1.

The group A is a divalent radical, linking the PS and PO blocks together. In their simplest form they may be a divalent alkylene group, for example of the general formula CₛH₂ₛ, where subscript s is as defined above, although preferably may be an alkylene group having from 2 to 10 carbon atoms, for example dimethylene, propylene, isopropylene, methylpropylene, isobutylene or hexylene, but they may also be other suitable linking groups between PS and PO blocks. These include for example divalent polyorganosiloxane groups terminated by diorganosilylalkylene units, for example —CₛH₂ₛ—[Si(R*₂)O]ₜSi(R*₂)CₛH₂ₛ—, wherein R* is as defined above for R″ except that here it cannot be an alkoxy group, and subscripts s and t are as defined above. A person skilled in the art will recognize that this is a non-limiting example of the group A. The group A is generally defined by the process used to link PO and PS groups together, as will be explained in more detail below. It is preferred that the divalent radical A is without any Si—O—C linkages.

A polyorganosiloxane polyoxyalkylene block copolymer of the form PS-(A-PO)ₘ-(A-PS)ₙ may be prepared in a hydrosilylation reaction by reacting a polyorganosiloxane having two Si—H groups (i.e., a PS precursor) with a polyether containing two aliphatically, preferably olefinically, more preferably ethylenically unsaturated groups (i.e., a PO precursor), optionally in the presence of a polyorganosiloxane having two aliphatically, preferably olefinically, more preferably ethylenically unsaturated groups, in an amount such that the Si—H groups are present in molar or number excess, at least to some extent, over the aliphatically unsaturated groups when the preferred block copolymers are being made, followed by a further reaction via hydrosilylation of the block copolymer intermediate thus obtained with alkoxy-functional organosilicon compounds, for example a silane or siloxane group having at least one silicon-bonded alkoxy group and one aliphatically unsaturated group. Aliphatically unsaturated group includes olefinically and acetylenically unsaturated groups, and in particular ethylenically unsaturated groups, which comprise a moiety which preferably has the formula >CH═CH₂, for example a vinyl, allyl or methallyl group. Alternatively, an aliphatically unsaturated group, which is selected from an olefinically unsaturated group with the unsaturation being between non-terminal carbon atoms, or an acetylenically unsaturated group, such as an alkynyl group, for example ethynyl or propynyl, may be used.

Where the polyorganosiloxane polyoxyalkylene block copolymer of the formula PO-(A-PS)ₘ-(A-PO)ₙ or PO-(A-PS-A-PO)ₙ is being prepared, alternatively to the method described above, a mixture could be used of a first polyether which contains two aliphatically, preferably olefinically, more preferably ethylenically unsaturated groups and a second polyether containing only one aliphatically unsaturated group which has an end-blocking group at the other end, such as an alkyl, hydroxyl, or acyl group. The second polyether would then form the terminal PO blocks in the block copolymer. However in this case a PS precursor is needed which has at least three silicon-bonded hydrogen atoms, so that the first two can be reacted to form the link with PO blocks via an A radical and the third and subsequent silicon-bonded hydrogen atoms can be further reacted with the alkoxy-group containing organosilicon compound. Where only the first polyether is used, the alkoxy functionality can be provided as indicated above, or alternatively by reacting the aliphatically unsaturated group available on the terminal PO blocks with an organosilicon compound having at least one alkoxy substituent, provided said organosilicon compound has instead of an aliphatically unsaturated substituent a silicon-bonded hydrogen atom to react with the aliphatically unsaturated end group of the PO block via addition reaction.

### Method for Making the Block Copolymer

The reaction between the PS precursors and the PO precursors and, for the more preferred block copolymer, the final reaction with the alkoxy substituted organosilicon compound is generally carried out in the presence of a hydrosilylation catalyst such as a platinum group metal or a complex or compound thereof, for example platinum, rhodium and complexes or compounds thereof. The divalent radicals A resulting from such preferred hydrosilylation reaction are alkylene radicals, having for example 2 to 6 carbon atoms depending on the aliphatically unsaturated group of the polyether used, or a α,ω-alkylene-endblocked polydiorganosiloxane, depending on the polyorganosiloxane having aliphatically unsaturated groups which was used.

Where a preferred polyorganosiloxane polyoxyalkylene block copolymer of the form PS-(A-PO-A-PS)ₙ is to be prepared, the process described above can be used, and the α,ω-alkylene-endblocked polydiorganosiloxane may be left out. If it is not left out, the chance of random distribution of A groups linking PS to PO and PS to PS cannot be easily controlled. However, polymers made according to either formula PS-(A-PO)ₘ-(A-PS)ₙ or PS-(A-PO-A-PS)ₙ will be eminently suitable for the curable compositions and for the hydrophilic polymer networks according to other aspects of this invention.

The polyorganosiloxane (PS precursor) which is reacted with the polyether (PO precursor) to form the block copolymer may be branched but is preferably a linear polydiorganosiloxane with a degree of polymerization (DP) ranging from 2 to 250 siloxane units, more preferably 2 to 200, even more preferably 4 to 40 siloxane units and most preferably 10 to 30 siloxane units. The organic groups which are substituents of the silicon atoms of the polyorganosiloxane are preferably selected from alkyl groups having 1 to 18, preferably 1 to 6, carbon atoms, and phenyl groups. Most preferably at least 90% of the organic groups attached to Si are methyl groups; for example the polyorganosiloxane is a Si—H functional polydimethylsiloxane. The polyorganosiloxane can contain more than two Si—H groups but this is likely to lead to a branched polyorganosiloxane polyoxyalkylene block copolymer. Most preferably the polyorganosiloxane PS precursor has only two Si—H groups, one at each end of the polydiorganosiloxane chain, so that reaction with the polyether produces a more preferred polyorganosiloxane-terminated block copolymer with reactive Si—H groups situated on the terminal silicon atoms of the intermediate polyorganosiloxane blocks of the block copolymer, as shown in the reaction scheme below, where m is as defined above and p has a value of at least 1, ready for further reaction with the alkoxy substituted organosilicon compounds.

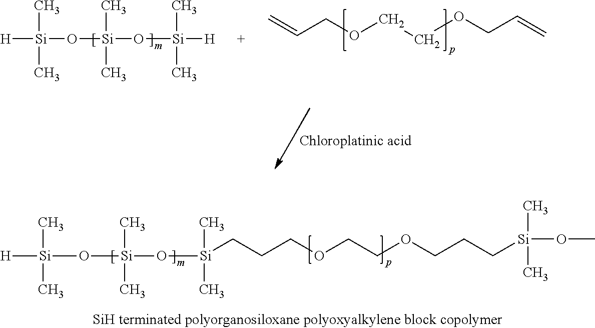

Polyorganosiloxanes having Si—H groups on non-terminal siloxane units, or on both terminal and non-terminal siloxane units, can alternatively be used.

The polyoxyalkylene (PO precursor) is preferably a polyethylene oxide, although a poly(oxyethylene oxypropylene) copolymer having a majority of polyoxyethylene units may be used. The preferred ethylenically unsaturated groups of the polyether can for example be allyl, vinyl, methallyl, hexenyl or isobutenyl groups. One example of a preferred polyether is polyethylene glycol diallyl ether. The polyethylene oxide preferably has a degree of polymerization (DP) of from 4 to 100, more preferably 4 to 40 oxyethylene units.

For the making of the more preferred block copolymers, the Si—H functional polyorganosiloxane (PS precursor) and the polyether containing aliphatically unsaturated groups (PO precursor) are preferably reacted at a molar ratio of Si—H groups to aliphatically, most preferably ethylenically unsaturated groups in the range 1.5:1 to 6:1, more preferably 2:1 to 4:1. The reaction can be carried out at ambient temperature but an elevated temperature in the range 60 to 200° C., for example 100 to 150° C., may be preferred. The reaction is generally carried out in the presence of a catalyst comprising a platinum group metal such as platinum or rhodium or a complex or compound thereof. One preferred platinum catalyst is hexachloroplatinic acid or a reaction product of chloroplatinic acid and an organosilicon compound containing terminal aliphatic unsaturation; another is a platinum divinyl tetramethyl disiloxane complex. The catalyst is preferably used in amounts from 0.00001-0.5 parts platinum or rhodium per 100 weight parts of the SiH-functional polyorganosiloxane, most preferably 0.00001-0.002 parts.

In addition to the hydrosilylation catalyst, particularly where it is a platinum based catalyst a suitable hydrosilylation catalyst inhibitor may be used. Any suitable platinum group type inhibitor may be used. One useful type of platinum catalyst inhibitor is described in U.S. Pat. No. 3,445,420, which is hereby incorporated by reference to show certain acetylenic inhibitors and their use. A preferred class of acetylenic inhibitors are the acetylenic alcohols, especially 2-methyl-3-butyn-2-ol and/or 1-ethynyl-2-cyclohexanol which suppress the activity of a platinum-based catalyst at 25° C. A second type of platinum catalyst inhibitor is described in U.S. Pat. No. 3,989,667, which is hereby incorporated by reference to show certain olefinic siloxanes, their preparation and their use as platinum catalyst inhibitors. A third type of platinum catalyst inhibitor includes polymethylvinylcyclosiloxanes having three to six methylvinylsiloxane units per molecule.

Where Si—H functional polyorganosiloxane (PS precursor) and the polyether containing aliphatically unsaturated groups (PO precursor) are reacted using a molar excess of the polyether containing the unsaturated groups, for example at a molar ratio of Si—H groups to unsaturated groups in the range 1:1.5 to 1:6, a block copolymer intermediate of the form PO-(A-PS-A-PO)ₙ or PO-(A-PS)ₘ-(A-PO)ₙ in which PO, PS, A, subscript m and subscript n are defined as above and the PO blocks have terminal aliphatically, preferably ethylenically, unsaturated groups, is produced.

When the more preferred polyorganosiloxane polyoxyalkylene intermediate block copolymers have been prepared as described above, they would then be further reacted with an organosilicon compound having at least one silicon-bonded alkoxy group and one aliphatically unsaturated group in order to obtain polyorganosiloxane polyoxyalkylene block copolymers according to the invention. This would ensure that the alkoxy group(s) would end up in the desired location, which for the most preferred block copolymers would be on the terminal silicon atoms of the block copolymer. Where the less preferred block copolymers have been prepared, having terminal PO units with aliphatically unsaturated end-groups, they would be further reacted with an organosilicon compound having at least one silicon-bonded alkoxy group and one silicon-bonded hydrogen atom.

The Si—OR containing organosilicon groups which can be reacted with the block copolymer intermediates as prepared above may be a compound containing an ethylenically unsaturated group or an Si—H group, thus having the general formula

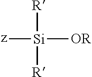

where Z is an aliphatically, preferably ethylenically unsaturated group such as vinyl, allyl, isobutenyl or 5-hexenyl, hydrogen or a polydiorganosiloxane group having an aliphatically, preferably ethylenically unsaturated substituent or a hydrogen atom to the terminal silicon atom. Examples of such organosilicon groups include silanes such as vinyl trimethoxysilane, allyl trimethoxysilane, methylvinyldimethoxysilane, hydrotrimethoxysilane and hydromethyldimethoxysilane. Suitable siloxane organosilicon compounds include vinyldimethyl end-blocked polydimethylsiloxane with a trimethoxysiloxane end-group.

A polyorganosiloxane polyoxyalkylene block copolymer containing more than two Si-bonded alkoxy groups is a self-cross-linkable polymer which can cure to a water-insoluble hydrophilic polymer network as described below. An example of such a block copolymer is a polyorganosiloxane polyoxyalkylene block copolymer terminated with

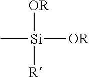

units where R and R′ are defined as above, for example a block copolymer of the form PS-(A-PO-A-PS)ₙ in which the reactive

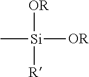

units are situated on the terminal silicon atoms of the polyorganosiloxane blocks.

The polyorganosiloxane polyoxyalkylene block copolymer containing Si-bonded alkoxy groups can alternatively be a block copolymer of the form PO-(A-PS-A-PO)ₙ. Such a block copolymer would be an intermediate having terminal ethylenically unsaturated groups and can be prepared as described above, which would then be reacted with a silane of the formula

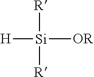

in which R and R′ are defined as above, to convert the ethylenically unsaturated groups into reactive groups of the formula

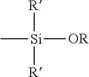

containing 1, 2 or 3 reactive alkoxy groups each attached to a silicon atom in the polyorganosiloxane polyoxyalkylene block copolymer according the first aspect of the invention. Examples of such silanes are trimethoxysilane, triethoxysilane, methyldiethoxysilane and dimethylethoxysilane. Particularly preferred are trialkoxysilanes.

### Cross-Linking Agent

The composition described above may optionally further comprise one or more additional ingredients. The composition may optionally also contain an organosilicon cross-linking agent having at least two alkoxy groups Y, preferably also silicon-bonded, reactive with the groups X, described above, by condensation reaction, provided that if the polyorganosiloxane polyoxyalkylene block copolymer has only two reactive groups X per molecule the organosilicon cross-linking agent is present and has, on average, more than two reactive silicon-bonded alkoxy groups Y, per molecule.

If the polyorganosiloxane polyoxyalkylene block copolymer has only two reactive groups X per molecule, the cross-linking agent generally has on average more than two reactive groups Y per molecule, for example 2.5 to 6 reactive groups per molecule, to aid network formation (cross-linking) rather than only chain extension, said network formation is required for the formation of the hydrophilic polymer network described below. For example, if the organosilicon cross-linking agent is a branched polyorganosiloxane containing at least three reactive groups Y, it can become bonded to at least 3 polymer chains resulting from the block copolymers described above.

The reactive groups X on the polyorganosiloxane polyoxyalkylene block copolymer can, for example, be present in siloxane units of the formula

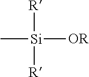

where R represents an alkyl group having 1 to 4 carbon atoms, and each R′ represents an alkyl group having 1 to 6 carbon atoms, a phenyl group, or an alkoxy group of the formula —OR. Examples of such groups are trimethoxysilyl, triethoxysilyl, methyldiethoxysilyl, methyldimethoxysilyl, dimethylmethoxysilyl and dimethylethoxysilyl.

The organosilicon cross-linking agent, when used is preferably a polysiloxane. The polysiloxane can, for example, consist of siloxane units selected from Q units of the formula (SiO_{4/2}), T units of the formula R^{c}SiO_{3/2}, D units of the formula R^{b}₂SiO_{2/2} and M units of the formula R^{a}₃SiO_{1/2}, where the R^{a}, R^{b}, and R^{c} substituents are selected from alkyl and alkoxy groups having 1 to 6 carbon atoms, at least three R^{a}, R^{b} and/or R^{c} substituents being alkoxy units. Alternatively, the cross-linking agent may be a branched polyorganosiloxane comprising T units, M units, and D units. The alkoxy groups are preferably present in the M units. Alternatively, the cross-linking agent may be a linear polydiorganosiloxane, i.e., having M units and D units. The alkoxy groups are preferably present in terminal positions (i.e., on the M units) of the polydiorganosiloxane crosslinker.

If the polyorganosiloxane polyoxyalkylene block copolymer is a block copolymer of the form PS-(A-PO-A-PS)ₙ in which the reactive Si—OR groups X are situated on the terminal silicon atoms of the polyorganosiloxane blocks, one suitable type of cross-linking agent is a branched polyorganosiloxane having silicon-bonded alkoxy groups Y situated on at least 3 branches. Such a branched polyorganosiloxane generally comprises Q and/or T units, M units and optionally D units. The alkoxy groups are preferably present in M units. The polyorganosiloxane can for example be a branched siloxane comprising one or more Q units of the formula (SiO_{4/2}), from 0 to 250 D units of the formula R^{b}₂SiO_{2/2} and M units of the formula R^{a}R^{b}₂SiO_{1/2}, wherein the R^{a} and R^{b} substituents are selected from alkyl and alkoxy groups having 1 to 6 carbon atoms, at least three R^{a} substituents in the branched siloxane being alkoxy groups. If the polyorganosiloxane polyoxyalkylene block copolymer is of relatively high chain length, a low molecular weight Q-branched siloxane cross-linking agent may be preferred, for example an alkoxy-functional Q-branched siloxane comprising a Q unit, four trialkoxysilyl M units, for example trimethoxysilyl M units and 0 to 20 dimethylsiloxane D units, which may have the formula

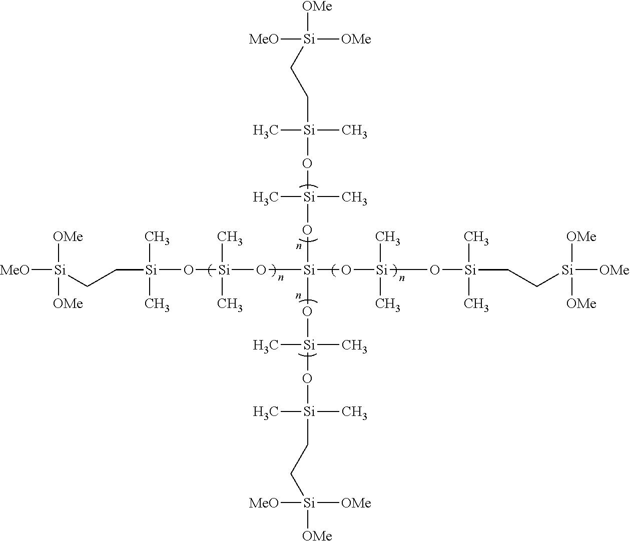

If the polyorganosiloxane polyoxyalkylene block copolymer contains more than two Si—OR groups, for example a block copolymer end-blocked by one or two siloxane units having at least 3 silicon-bonded alkoxy groups or two siloxane units each having at least 2 silicon-bonded alkoxy groups or a rake copolymer containing 3 or more Si—OR groups, the organosilicon cross-linking agent need not contain more than 2 silicon-bonded alkoxy groups. For example the cross-linking agent can be a polydiorganosiloxane containing 2 silicon-bonded alkoxy groups such as a dimethylmethoxysilyl-terminated polydimethylsiloxane, or can be a mixture of such a polydiorganosiloxane containing 2 silicon-bonded alkoxy groups with a branched polyorganosiloxane having silicon-bonded alkoxy groups Y situated on at least 3 branches. However, if the polyorganosiloxane polyoxyalkylene block copolymer has more than 2 silicon-bonded alkoxy groups, than the organosilicon cross-linking agent may be omitted.

Usually it is preferred that the cross-linking agent, if used, for provision of reactive Si-bonded alkoxy groups Y is an organopolysiloxane, for example a polydiorganosiloxane such as polydimethylsiloxane having end units of the formula

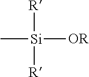

particularly such end units where at least one of the R′ groups is an alkoxy group, or a branched polyorganosiloxane in which each branch is terminated with a group of the formula

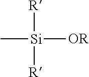

The cross-linking agent of the curable composition where the polyorganosiloxane polyoxyalkylene block copolymer is terminated with reactive groups of the formula

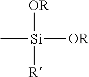

can alternatively or additionally comprise a branched polyorganosiloxane containing

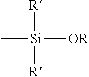

groups, where R and R′ are defined as above. The branched polyorganosiloxane can for example be a Q-branched polysiloxane in which each branch is terminated with a

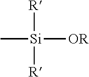

group. Such branched polyorganosiloxanes can be formed by the reaction of an ethylenically unsaturated branched polyorganosiloxane, for example the vinyl-functional Q-branched siloxane described above, with a short chain polysiloxane containing a Si—H group and a group of the formula

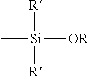

for example a polysiloxane of the formula

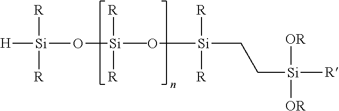

in the presence of a platinum group metal catalyst, where R and R′ are as defined above. The branched polyorganosiloxane cross-linking agent can alternatively be prepared from a branched polyorganosiloxane containing Si—H groups, for example a Q-branched polysiloxane having terminal dimethylhydrogensilyl groups, with an ethylenically unsaturated alkoxysilane of the formula

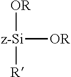

where each R, R′ and Z is as defined above. It may be preferred to use a mixture of an alkoxy-terminated polydiorganosiloxane with an alkoxy-terminated Q-branched polysiloxane.

The cross-linking agent, if used, can also be prepared by a hydrosilylation reaction. For example, a Si—H terminated polyorganosiloxane can be reacted with an ethylenically unsaturated alkoxysilane. Alternatively a polyorganosiloxane containing ethylenically unsaturated groups can be reacted with a polysiloxane containing a Si—H group and at least one Si-alkoxy group.

The reactive groups Y on the cross-linking agent can also be present in silane or siloxane units of the formula

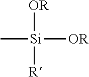

wherein R and R′ have the meanings given above. In its simplest form the cross-linking agent can be a tetraalkoxysilane, such as tetramethoxysilane or tetraethoxysilane, a trialkoxysilane, for example an alkyltrialkoxysilane such as methyltrimethoxysilane, methyltriethoxysilane, ethyltriethoxysilane or n-octyltriethoxysilane, or a dialkoxysilane, for example a dialkyldimethoxysilane such as dimethyldiethoxysilane, or a tetraalkoxysilane such as tetraethoxysilane.

If the polyorganosiloxane polyoxyalkylene block copolymer contains only two Si-bonded alkoxy groups, the organosilicon cross-linking agent should contain more than two Si-bonded alkoxy groups, for example it can be a trialkoxysilane or a polysiloxane containing at least one —Si(OR)₃ unit where R is defined as above, or a polysiloxane containing at least two

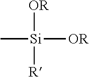

units where R′ is an as described above, or a polysiloxane containing at least three

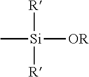

units where R′ is as described above.

If the polyorganosiloxane polyoxyalkylene block copolymer contains more than two Si-bonded alkoxy groups, an organosilicon cross-linking agent containing only two Si-bonded alkoxy groups and/or an organosilicon cross-linking agent containing more than two Si-bonded alkoxy groups can be used. Alternatively, such a polyorganosiloxane polyoxyalkylene block copolymer containing more than two Si-bonded alkoxy groups can be cured by reaction of the Si-alkoxy groups with each other in the presence of moisture, and preferably a condensation reaction catalyst such as a transition metal catalyst, without need for a further cross-linking agent.

It will be appreciated that some cross-linking between polyorganosiloxane polyoxyalkylene block copolymer chains terminated with reactive groups of the formula

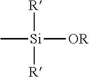

may take place even there is a cross-linking agent present. It may be preferred to use a minor amount of cross-linking agent to control the properties of the cured polymer composition. For example a branched polyorganosiloxane containing Si-alkoxy groups can be added to increase the degree and/or density of cross-links, leading to harder cured polymer composition. An alkoxy-terminated polydiorganosiloxane of relatively high chain length, for example polydimethylsiloxane of DP 100 up to 250 or even 500 can be added to decrease the cross-link density, leading to a more flexible cured polymer composition. The overall proportion of alkoxy-functional polyorganosiloxane polyoxyalkylene block copolymer to other alkoxy-functional polyorganosiloxane(s) can be any value in the range 100:0 to 10:90.

### Cross-Linking

For some uses where the curable composition has to be applied in situ, for example as a coating or sealant, it may not be feasible to carry out the cross-linking reaction at elevated temperature. Fortunately a cross-linking reaction via condensation of silicon-bonded alkoxy group proceeds fast at ambient temperature. Such reactions of Si-alkoxy groups with each other may take place in the presence of moisture. Additionally the reaction may be conducted with other organosilicon compounds having acetoxy, ketoxime, amide or hydroxyl groups bonded to silicon.

Since a polyorganosiloxane polyoxyalkylene block copolymer having Si-alkoxy groups and a cross-linking agent having Si-alkoxy groups do not react in the absence of moisture, even in the presence of the catalyst, a curable composition based on them can be stored in a single container, provided that the reagents are dry and the container is moisture-proof. Upon opening of the container, the curable composition can be applied to a surface and will generally cure in the presence of atmospheric moisture. Cure proceeds rapidly at ambient temperature.

One type of curable composition according to the invention comprises a polyorganosiloxane polyoxyalkylene block copolymer containing Si-alkoxy groups of the formula

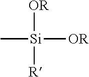

wherein each R represents an alkyl group having 1 to 4 carbon atoms and R′ represents an alkyl group having 1 to 6 carbon atoms, a phenyl group, or an alkoxy group of the formula —OR; PO represents a polyoxyalkylene block, A represents a divalent radical and n has a value of at least 1, and a siloxane condensation catalyst, the composition being packed in a moisture-proof container.

The polyorganosiloxane polyoxyalkylene block copolymer terminated with reactive groups of the formula

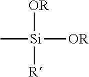

has 2 or 3 reactive Si-bonded alkoxy groups at each end of the block copolymer chain. It does not need to be reacted with a highly functional or branched cross-linker to form a network. The cross-linker used with such a polyorganosiloxane polyoxyalkylene block copolymer can for example be a polydiorganosiloxane, for example a polydimethylsiloxane, terminated with Si-alkoxy groups such as groups of the formula

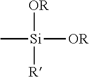

Such an alkoxy-terminated polydiorganosiloxane can be prepared by reaction of a Si—H terminated polydiorganosiloxane with an ethylenically unsaturated alkoxysilane of the formula

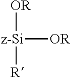

where z is an aliphatically unsaturated group such as vinyl, allyl, isobutenyl or 5-hexenyl, or a polydiorganosiloxane group having an aliphatically unsaturated substituent in the presence of a platinum group metal catalyst. The polydiorganosiloxane can for example be a polydimethylsiloxane of DP in the range 4 to 500 siloxane units.

The curable composition may optionally further comprise, in addition to the polyorganosiloxane polyoxyalkylene block copolymer, a polyorganosiloxane containing no polyoxyalkylene moieties but having the same reactive silicon-bonded alkoxy groups X. The polyorganosiloxane can for example be a polydiorganosiloxane such as polydimethylsiloxane which is terminated with the reactive groups X. When the cross-linking agent is simultaneously reacted with the polyorganosiloxane polyoxyalkylene block copolymer and the polyorganosiloxane having the same reactive groups X, the polyorganosiloxane is reacted into the water-insoluble hydrophilic polymer network. The proportion of polyorganosiloxane polyoxyalkylene block copolymer to the polyorganosiloxane having the same reactive groups X can be any value in the range 100:0 to 10:90.

### Filler

The curable compositions can be unfilled or can contain a reinforcing or non-reinforcing filler. Examples of suitable fillers include silica, including fumed silica, fused silica, precipitated silica, barium sulphate, calcium sulphate, calcium carbonate, silicates (such as talc, feldspar and china clay), bentonite and other clays and solid silicone resins, which are generally condensed branched polysiloxanes, such as a silicone resin comprising Q units of the formula (SiO_{4/2}) and M units of the formula R^{m}₃SiO_{1/2}, wherein the R^{m} substituents are selected from alkyl groups having 1 to 6 carbon atoms and the ratio of M units to Q units is in the range 0.4:1 to 1:1.

### Hydrophilic Polymer Network

A water-insoluble hydrophilic polymer network may be provided by curing the composition described above. The water-insoluble hydrophilic polymer network comprises polyorganosiloxane polyoxyalkylene block copolymer moieties linked to each other by bonds between cross-linking sites on silicon atoms through condensation reaction of silicon-bonded alkoxy groups which were present on ingredient (B) the polyorganosiloxane polyoxyalkylene block copolymer prior to network formation and/or through an organosilicon cross-linking moiety bonded to cross-linking sites on silicon atoms through the condensation reaction of silicon-bonded alkoxy groups which were present on the polyorganosiloxane polyoxyalkylene block copolymer moieties and on the organosilicon cross-linking moiety prior to network formation.

A process for forming such hydrophilic polymer networks comprises reacting the curable composition described above. This means reacting two or more polyorganosiloxane polyoxyalkylene block copolymer having at least two reactive silicon-bonded alkoxy groups X with each other via condensation reaction, optionally in the presence of an organosilicon cross-linking agent having at least two silicon-bonded alkoxy groups Y reactive with the said groups X, provided that if the polyorganosiloxane polyoxyalkylene block copolymer has only two reactive groups X per molecule the cross-linking agent is present and has on average more than two reactive groups Y per molecule.

The water-insoluble hydrophilic polymer network can thus comprise polyorganosiloxane polyoxyalkylene block copolymer moieties linked to each other through Si—O—Si linkages derived from Si-alkoxy derived cross-linking sites on silicon atoms of the polyorganosiloxane polyoxyalkylene block copolymers prior to formation of the network, preferably located on polyorganosiloxane blocks of the polyorganosiloxane polyoxyalkylene block copolymers.

The polymer networks produced by curing compositions described herein are substantially water-insoluble and have unusual hydrophilic properties. The surface of the cured polymer network is somewhat hydrophobic in the dry state, but becomes hydrophilic when the surface is wetted with water or an aqueous liquid. This effect is reversible. When the wetted surface is allowed to dry, it regains its hydrophobic properties, and can be made hydrophilic again by rewetting. Hydrophilic polymer networks with such properties are produced particularly if the sum of the DP of the polysiloxane and the DP of the polyethylene oxide in the block copolymer range from 15 to 35.

This reversible hydrophilicity can be observed by applying droplets of water to the surface and observing the droplets over time. When the droplet is first applied to the surface, it remains as a droplet on the surface and the contact angle of the water on the surface can be measured. This contact angle typically ranges from 60° to 120° when measured 2 seconds after application of the droplet to the surface and is usually still above 60° 30 seconds after application, but the water droplet spreads over time and the contact angle has generally decreased by at least 10° after 3 minutes and continues to decrease; the contact angle is generally below 60° and may be below 30° 10 minutes after application of the droplet indicating a hydrophilic surface. The change from a hydrophobic surface to a more hydrophilic surface is still observed when part of the polyorganosiloxane polyoxyalkylene block copolymer in the polymer network is replaced by a polydiorganosiloxane, although the extent of change, as measured by decrease in contact angle with water, is reduced as the proportion of polyorganosiloxane polyoxyalkylene block copolymer in the polymer network is reduced. When the surface is then dried and a water droplet is applied to the dried surface, the contact angle measured 2 seconds after application of the droplet to the surface is substantially the same as the contact angle measured after the first application of the water droplet, and the contact angle decreases over time at substantially the same rate as after the first application.

### Methods of Use

The polymer compositions of the invention can be used in various applications in which a polymer surface has to be in contact with water or an aqueous liquid and hydrophilic properties are required. The polymer composition can be applied to a surface as a coating or sealant and cured in situ on the surface to a water-insoluble hydrophilic polymer network. Alternatively the polymer composition can be shaped, for example by extrusion, and then cured to form the polymer network.

The invention is illustrated by the following Examples in which all parts and percentages are by weight, unless otherwise indicated. In this description, EO/PDMS ratio refers to the molar ratio of oxyethylene units to dimethylsiloxane units in the block copolymer.

### Reference Example 1

### Tack Free Time (TFT) Test

The tack free time, a measure of cure rate, was defined as the time in minutes required for a curing composition to form a non-tacky surface film when touched with a gloved finger. Steel test plates, also called ‘Q Panels’ were used for ‘drawdowns’. These plates were rubbed with a small amount of acetone and a rag to remove any particles or dirt so as to create equal conditions of all test plates. After a sample sat for 30 minutes, and the Q panels were free from acetone, drawdown of the sample was performed by applying a composition on one end of the panel and spreading the composition across the panel in an even coating using a drawdown bar with a 100 μm gap between the drawdown bar and the panel. A 100 μm thick wet film was prepared on each test panel. The test panel was touched with a gloved finger (disposable nitrile gloves)—the glove was pulled toward the skin. When the finger was released from the panel, an assessment of the test panels' (Q-panel) stickiness or tackiness was made. If no stickiness or tackiness was observed then the composition on the panel had cured, and the time taken from drawdown to tack free stage was recorded as the sample's ‘tack free time’. The appearance of the test panel was also recorded. This data illustrates the compatibility of the samples and records any separation of materials, gelling, or discoloration.

### Example 1

### Ethoxy Functional Block Copolymer

A three neck, round bottom flask equipped with a temperature probe, an electrical stirrer, and a condenser was charged with 79 grams of vinyl-terminated polydimethylsiloxane having an average DP of 50, 0.513 gram of hydrogen terminated polydimethylsiloxane having an average DP of 20, 108 gram of oxyethylene with Mn of 400, 0.14 g sodium acetate and 175 grams of toluene. The reaction mixture was heated to 105° C. under nitrogen and stirred at 200 rpm for 1 hour. After this, 0.53 gram of catalyst (chloroplatinic acid at 0.5% concentration) was added dropwise to the mixture. After stabilization of the exotherm, the remaining ¼ of the catalyst was added, and the reaction was allowed to react for one hour at 85° C. Next, 42 grams of allyl triethoxysilane was added to the reaction mixture and allowed to react for 3 additional hours. The unreacted allyl triethoxysilane and toluene were then removed via vacuum stripping. The resulting copolymer was a triethoxysilylpropylene-terminated poly(dimethylsiloxane/oxyethylene) block copolymer having a Mn of 9,937, an EO/PDMS ratio of 0.2, and oxyethylene blocks with Mn of 400. Mn represents the number average molecular weight measured using gel permeation chromatography. Samples were prepared by mixing the copolymer and a catalyst. DOW CORNING® 4-6085 was a silyl phosphonate catalyst comprising an equilibrium mixture of (trimethylsilyl)octyl phosphonic acid, octylphosphonic acid, and bis(trimethylsilyl)octylphosphonate. DBTDL was dibutyl tin dilaurate, used as a control catalyst. The catalyst and amount used in each sample are in Table 1, below. The balance of each mixture was the block copolymer. Tack Free Time was tested for each sample according to the procedure in Reference Example 1.

TABLE 1

| | Amount of | Tack Free Time |
|---|---|---|
| Catalyst | Catalyst | (hours) |
| Dow Corning ® 4-6085 | 2% | 4 |
| Dow Corning ® 4-6085 | 3% | 3 |
| Dow Corning ® 4-6085 | 4% | 3 |
| Dow Corning ® 4-6085 | 5% | 3 |
| DBTDL (control) | 2% | >24 |
| DBTDL (control) | 3% | >24 |
| DBTDL (control) | 4% | >24 |
| DBTDL (control) | 5% | >24 |

Dow Corning® 4-6085, the silyl phosphonate catalyst, showed faster cure than the dibutyltin dilaurate (DBTDL) control at each catalyst loading tested using this ethoxy terminated block copolymer.

### Example 2

### Methoxy Functional Block Copolymer

Samples were prepared by mixing a catalyst with a trimethoxysilylpropylene-terminated poly(dimethylsiloxane/oxyethylene) block copolymer having a Mn of 9,671, an EO/PDMS ratio of 0.18, and oxyethylene blocks with Mn of 400. The catalyst and amount used in each sample are in Table 2, below. The balance of each mixture was the block copolymer. Tack Free Time was tested for each sample according to the procedure in Reference Example 1.

TABLE 2

| Catalyst | Amount of Catalyst | Tack Free Time (hours) |
|---|---|---|
| Dow Corning ® 4-6085 | 0.5% | 3 |
| Dow Corning ® 4-6085 | 1% | 1 |
| DBTDL (control) | 1% | 5 |

Example 2 shows that the silyl phosphonate catalyst showed faster cure than the dibutyltin dilaurate control even when a lower catalyst loading was used for this block copolymer.

### Example 3

Samples were prepared by mixing a catalyst with a trimethoxysilylpropylene-terminated poly(dimethylsiloxane/oxyethylene) block copolymer having a Mn of 9,662, an EO/PDMS ratio of 0.22, and oxyethylene blocks with Mn of 595. The catalyst and amount used in each sample are in Table 3, below. For the DBDTL control, the sample contained 1.5% DBTDL, 7% tetraethoxysilane, with the balance being the block copolymer. The other samples contained 1% catalyst with the balance of each mixture being the block copolymer. Tack Free Time was tested for each sample according to the procedure in Reference Example 1. TnBT refers to tetra-n-butyl titanate.

TABLE 3

| | | Tack Free | |
|---|---|---|---|
| | | Time | Appearance of the |
| Catalyst | Amount | (hours) | Film |
| DBDTL (control) | 1.5% | 3 | Clear glossy film but |
| | | | turns brown over time |
| TnBT (control) | 1% | 5 | Clear, glossy, smooth |
| | | | film |
| Dow Corning ® 4-6085 | 1% | 1 | Clear, glossy, smooth |
| | | | film |

Example 3 shows that the silyl phosphonate catalyst showed faster cure than both the tin and titanate catalyst controls for this block copolymer. Example 3 also slows less propensity for dicoloration when the silyl phosphonate catalyst is used, as compared to the control sample using a tin catalyst under these conditions. Without wishing to be bound by theory, it is thought that use of a catalyst as described herein may result in a reaction product that is clear and/or colorless.

### Example 4

A three neck, round bottom flask equipped with a temperature probe, an electrical stirrer, and a condenser was charged with 37 grams of vinyl-terminated polydimethylsiloxane having an average DP of 50, 216 grams of hydrogen terminated polydimethylsiloxane having an average DP estimated to be 10, 47 grams of oxyethylene with Mn of 300, and 25 grams of toluene. The reaction mixture was heated to 105° C. under nitrogen and stirred at 200 rpm for 1 hour. Next, 0.075 gram of catalyst (chloroplatinic acid, 0.5%) was added dropwise to the mixture. After stabilization of the exotherm, the remaining ¼ of the catalyst was added and the reaction was allowed to react for one hour at 85° C. Next, 20 grams of allyl trimethoxysilane was added to the reaction mixture and allowed to react for 3 additional hours. The unreacted allyl trimethoxysilane and toluene were then removed via vacuum stripping. The resulting copolymer was Base Polymer 4a, which was a trimethoxysilylpropylene-terminated poly(dimethylsiloxane/oxyethylene) block copolymer having a Mn of 7,249, an EO/PDMS ratio of 0.24, and oxyethylene blocks with Mn of 300.

A three neck, round bottom flask equipped with a temperature probe, an electrical stirrer, and a condenser was charged with 343 grams of vinyl-terminated polydimethylsiloxane having an average DP of 50, 325 grams of hydrogen-terminated polydimethylsiloxane having an average DP of 20, 31 grams of oxyethylene with Mn of 400, 0.14 gram of sodium acetate, and 175 grams of toluene. The reaction mixture was heated to 105° C. under nitrogen and stirred at 200 rpm for 1 hour. Next, 0.53 gram of catalyst (chloroplatinic acid 0.5% t) was added dropwise to the mixture. After stabilization of the exotherm, the remaining ¼ of the catalyst was added and the reaction was allowed to react for one hour at 85° C. After this, 30 grams of allyl trimethoxysilane was added to the reaction mixture and allowed to react for 3 additional hours. The unreacted allyl trimethoxysilane and toluene were then removed via vacuum stripping. The resulting copolymer was Base Polymer 4b, which was a trimethoxysilylpropylene-terminated poly(dimethylsiloxane/oxyethylene) block copolymer having a Mn of 11,564, an EO/PDMS ratio of 0.08, and oxyethylene blocks with Mn of 400.

A three neck, round bottom flask equipped with a temperature probe, an electrical stirrer, and a condenser was charged with 79 grams of vinyl-terminated polydimethylsiloxane having an average DP of 50, 512 grams of hydrogen terminated polydimethylsiloxane having an average DP of 20, 108 grams of oxyethylene with Mn of 400, 0.14 gram of sodium acetate and 175 grams of toluene. The reaction mixture was heated to 105° C. under nitrogen and stirred at 200 rpm for 1 hour. After this, 0.53 gram of catalyst (chloroplatinic acid 0.5%) was added dropwise to the mixture. After stabilization of the exotherm, the remaining ¼ of the catalyst was added and the reaction was allowed to react for one hour at 85° C. Next, 34 grams of allyl trimethoxysilane was added to the reaction mixture and allowed to react for 3 additional hours. The unreacted allyl trimethoxysilane and toluene were then removed via vacuum stripping. The resulting copolymer was Base Polymer 4c, which was a trimethoxysilylpropylene-terminated poly(dimethylsiloxane/oxyethylene) block copolymer having a Mn of 10,133, an EO/PDMS ratio of 0.21, and oxyethylene blocks with Mn of 400.

A three neck, round bottom flask equipped with a temperature probe, an electrical stirrer, and a condenser was charged with 25 grams of vinyl-terminated polydimethylsiloxane with an average DP of 50, 332 grams of hydrogen terminated polydimethylsiloxane with an average DP of 8, 143 grams of oxyethylene with Mn of 400, 0.14 gram of sodium acetate and 175 grams of toluene. The reaction mixture was heated to 105° C. under nitrogen and stirred at 200 rpm for 1 hour. After this, 0.53 gram of catalyst (chloroplatinic acid 0.5%) was added dropwise to the mixture. After stabilization of the exotherm, the remaining ¼ of the catalyst was added and the reaction was allowed to react for one hour at 85° C. Next, 27 grams of allyl trimethoxysilane was added to the reaction mixture and allowed to react for 3 additional hours. The unreacted allyl trimethoxysilane and toluene were then removed via vacuum stripping. The resulting copolymer was Base Polymer 4d, which was a trimethoxysilylpropylene-terminated poly(dimethylsiloxane/oxyethylene) block copolymer having a Mn of 9,000, an EO/PDMS ratio of 0.46, oxyethylene blocks with Mn of 400.

Samples are prepared by mixing Dow Corning® 4-6085 with the block copolymers, which were prepared as described above in this example 4. Each sample contains 1% Dow Corning® 4-6085 with the balance being the block copolymer.

### Example 5

Block Copolymer samples were prepared by combining vinyl-terminated polydimethylsiloxane, SiH-terminated polydimethylsiloxane, polyether and toluene in a three neck round bottom flask. The reaction mixture was heated to 105° C. under nitrogen and stirred at 200 rpm for 1 hour. Catalyst (chloroplatinic acid 0.5%) was added dropwise to the mixture. After stabilization of the exotherm, the remaining one quarter of the catalyst was added and the reaction was allowed to react for one hour at 85° C. A molar excess of allyl trimethoxysilane was then added to the reaction mixture and allowed to react for 3 additional hours. The unreacted allyl trimethoxysilane and the toluene were then removed via vacuum stripping.

Samples are prepared by mixing Dow Corning® 4-6085 with the following block copolymers, which were prepared as described above. Each sample contains 1% catalyst with the balance being the block copolymer.

Base Polymer 5a is a trimethoxysilylpropylene-terminated poly(dimethylsiloxane/oxyethylene) block copolymer having a Mn of 11,082, an EO/PDMS ratio of 0.08, and oxyethylene blocks with Mn of 300.

Base Polymer 5b is a trimethoxysilylpropylene-terminated poly(dimethylsiloxane/oxyethylene) block copolymer having a Mn of 8,291, an EO/PDMS ratio of 0.34, and oxyethylene blocks with Mn of 300.

Base Polymer 5c is a trimethoxysilylpropylene-terminated poly(dimethylsiloxane/oxyethylene) block copolymer having a Mn of 7,963, an EO/PDMS ratio of 0.31, and oxyethylene blocks with Mn of 400.

Base Polymer 5d is a trimethoxysilylpropylene-terminated poly(dimethylsiloxane/oxyethylene) block copolymer having a Mn of 13,283, an EO/PDMS ratio of 0.07, and oxyethylene blocks with Mn of 500.

Base Polymer 5e is a trimethoxysilylpropylene-terminated poly(dimethylsiloxane/oxyethylene) block copolymer having a Mn of 8,763, an EO/PDMS ratio of 0.35, and oxyethylene blocks with Mn of 595.

Base Polymer 5f is a trimethoxysilylhexylene-terminated poly(dimethylsiloxane/oxyethylene) block copolymer having a Mn of 9,000, an EO/PDMS ratio of 0.205, and oxyethylene blocks with Mn of 400.

### Example 6

Coating composition 1 was prepared by mixing the following ingredients.

| Component | Parts by weight |
|---|---|
| Condensation cure Polysiloxane polyoxyethylene block | 81.3 |
| copolymer | |
| silica | 7.2 |
| Sodium Alumino Sulphosilicate | 7.0 |
| xylene | 4.1 |
| Octyl Silyl Phosphonate | 0.5 |

### Example 7

Coating composition 2 was prepared by mixing the following ingredients

| Component | Parts by weight |
|---|---|
| Condensation cure Polysiloxane polyoxyethylene block | 81.3 |
| copolymer | |
| silica | 7.2 |
| Sodium Alumino Sulphosilicate | 7.0 |
| 2,4-pentanedione | 4.1 |
| Dibutyl Tin Dilaurate | 0.5 |

### Example 8

For comparison, for coating composition 3 Intersleek® 900, a product available from International Paint was taken.

All products were applied to plywood panels, cured (at 15 to 20° C. at 30 to 80% relative humidity) for several hours and after curing immersed in a static fouling rig at Newton Ferrers (UK). The total fouling on these panels was assessed at certain time intervals after immersion. The results of these assessments are given in the table below

TABLE
Results of fouling assessment in static immersion test.

| | Time of Immersion | Total Fouling |
|---|---|---|
| Example | (weeks) | (%) |
| Coating composition 1 | 45 | 6.17 |
| Coating composition 2* | 45 | 24.27 |
| Coating composition 3* | 45 | 14.21 |
| Coating composition 1 | 84 | 18.67 |
| Coating composition 2* | 84 | 35.68 |
| Coating composition 3* | 84 | 24.46 |
| Coating composition 1 | 110 | 23.96 |
| Coating composition 2* | 110 | 64.02 |
| Coating composition 3* | 110 | 66.00 |

*Comparative example

1. A condensation reaction curable composition comprises:
(A) a phosphonate catalyst, and
(B) a polyorganosiloxane polyoxyalkylene block copolymer having one or more polyorganosiloxane blocks and one or more polyoxyalkylene blocks linked to each other via divalent radicals and which comprises at least two silicon-bonded alkoxy groups,
with the proviso that when ingredient (B) contains only two silicon-bonded alkoxy groups, then the composition further comprises a cross-linking agent.

2-3. (canceled)

4. The composition of claim 1, where ingredient (A) has average general formula (i): 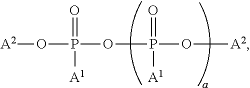
where
each A¹ is independently a monovalent hydrocarbon group;
each A² is independently selected from a hydrogen atom, a monovalent organic group, a silyl group of formula —SiA³₃, or a siloxane group;
each A³ is independently a monovalent hydrocarbon group; and
subscript a has a value of 0 or greater.

5. The composition of claim 4, where each A¹ is independently an alkyl group or an alkenyl group; each A² is independently a hydrogen atom, a monovalent hydrocarbon group, or a silyl group; and subscript a has a value ranging from 0 to 50.

6. The composition of claim 4, where each A¹ is independently an alkyl group of 1 to 8 carbon atoms or an alkenyl group of 1 to 8 carbon atoms; and each A² is independently a hydrogen atom, an alkyl group of 1 to 4 carbon atoms, or a silyl group in which each A³ is independently an alkyl group of 1 to 4 carbon atoms.

7. The composition of claim 1, where ingredient (A) comprises diethenyl-diphosphonic acid, vinylphosphonic acid, bis(trimethylsilyl)vinylphosphonate, trimethylsilyl vinylphosphonic acid, bis(dimethylvinylsilyl)vinylphosphonate, dimethylvinylsilyl vinylphosphonic acid, dimethyl methylphosphonate, bis(trimethylsilyl)octylphosphonate, trimethylsilyl octylphosphonate, and octylphosphonic acid, or a combination thereof.

8. The composition of claim 7, where ingredient (A) comprises a mixture of bis(trimethylsilyl)octylphosphonate, trimethylsilyl octylphosphonate, and octylphosphonic acid.

9. The composition of claim 1, where the polyorganosiloxane polyoxyalkylene block copolymer has formula: PS-(A-PO)ₘ-(A-PS)ₙ, where PO is a polyoxyalkylene block, PS represents a polyorganosiloxane block, A is a divalent radical, subscripts m and n have independently a value of at least 1, where the copolymer comprises at least one alkoxy-substituted siloxane unit of the formula (R′)_{q}(OR)—SiO_{3-q/2}, wherein R represents an alkyl group having 1 to 4 carbon atoms and each R′ represents an alkyl group having 1 to 6 carbon atoms, a phenyl group, or an alkoxy group of the formula —OR and q has a value of 0, 1 or 2, provided at least two silicon-bonded groups OR are present in the block copolymer.

10. The composition of claim 9, where the polyorganosiloxane polyoxyalkylene block copolymer has formula PS-(A-PO-A-PS)ₙ.

11. The composition of claim 10, where the polyorganosiloxane polyoxyalkylene block copolymer has terminal PS blocks, and the terminal PS blocks each have an alkoxy-substituted siloxane unit which is linked via oxygen to another silicon atom of the terminal PS block and which has the formula

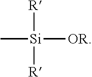

12. The composition of claim 9, where the PS blocks are mainly polydimethylsiloxane blocks having from 4 to 40 siloxane units.

13. The composition of claim 9, where the alkoxy groups are selected from methoxy groups and ethoxy groups.

14-15. (canceled)

16. The composition of claim 9, where the PO block has general formula —(CₛH₂ₛO)ₜ— where each subscript s independently has a value of from 2 to 6 and each subscript t independently has a value of from 4 to 40.

17. The composition of claim 16, where A is a divalent radical, linking the PS and PO blocks together, and A is selected from a divalent alkylene group having from 2 to carbon atoms and a divalent polyorganosiloxane group terminated by diorganosilylalkylene units of the general formula —CₛH₂ₛ—[Si(R*₂)O]ₜSi(R*₂)CₛH₂ₛ—, where R* is defined as alkyl, aryl, alkaryl or aralkyl having from 1 to 18 carbon.

18. The composition of claim 1, further comprising (C) an organosilicon cross-linking agent having at least two silicon-bonded alkoxy groups reactive with the silicon bonded alkoxy groups of ingredient (B) by condensation reaction, provided that if ingredient (B) has only two alkoxy groups per molecule, ingredient (C) is present and has on average more than two reactive silicon-bonded alkoxy groups per molecule.

19. The composition of claim 18, where ingredient (C) is a polysiloxane comprising siloxane units selected from Q units of the formula (SiO_{4/2}), T units of the formula R^{c}SiO_{3/2}, D units of the formula R^{b}₂SiO_{2/2} and M units of the formula R^{a}₃SiO_{1/2}, wherein the R^{a}, R^{b}, and R^{c} substituents are selected from alkyl and alkoxy groups having 1 to 6 carbon atoms, at least three R^{a}, R^{b}, and/or R^{c} substituents being alkoxy units.

20. The composition of claim 19, where the cross-linking agent is a polydiorganosiloxane comprising D units and M units, and the alkoxy groups are bonded to the M units.

21. The composition of claim 9, where on average each of the polyorganosiloxane polyoxyalkylene block copolymers present has more than two reactive silicon bonded alkoxy groups and in which no cross-linking agent is present.

22. The composition of claim 18, which further comprises a polyorganosiloxane containing no polyoxyalkylene moieties but having the one or more reactive silicon-bonded alkoxy groups.

23. The composition of claim 1, which further comprises a filler selected from the group consisting of silica, including fumed silica, fused silica, precipitated silica, barium sulphate, calcium sulphate, calcium carbonate, silicates, including talc, feldspar and china clay, bentonite and other clays and solid silicone resins.

24. A process for forming a cured product comprising: reacting a curable composition according to claim 1 in the presence of moisture.

25. A water-insoluble hydrophilic polymer network provided by curing the composition according to claim 1, where a surface of the polymer network becomes more hydrophilic on wetting with water, as shown by the contact angle of a water droplet on a surface of the polymer network decreasing with time after application of the water droplet to the surface and reversibly becomes more hydrophobic on drying of the polymer network surface.

26. A cured product prepared by the process of claim 24, where the cured product is clear and/or colorless.
